(19) United States
(12) Patent Application Publication
(10) Pub. No.: US 2010/0089888 A1
(43) Pub. Date: Apr. 15, 2010

(54) Apparatuses and methods for welding and for improving fatigue life of a welded joint

(75) Inventors: James Anthony Forck, Peoria, IL (US); Alexei Peter Yelistratov, Dunlap, IL (US); Mark Wayne Hammerton, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/285,659

(22) Filed: Oct. 10, 2008

(51) Int. Cl. B23K 9/00; C21D 1/40

(52) U.S. Cl. 219/136; 219/162

(57) ABSTRACT

A method for welding an edge of a first member to a side surface of a second member is provided. The first member and the second member are joined to one another at a joint. The method includes beveling an edge of the first member. The method also includes positioning the edge of the first member proximate the side surface of the second member. The method further includes supplying welding material via a welding wire along the edge of the first member to create a joint between the first and second members. Supplying welding material includes controlling a feed rate of the welding wire, such that a weld bead formed at the joint defines a concave cross-section.

### TECHNICAL FIELD

The present disclosure relates generally to apparatuses and methods for welding and joining two members, and more particularly, to apparatuses and methods for improving fatigue life of a welded joint.

### BACKGROUND

One concern with welded joints relates to weld fatigue. Weld fatigue failure is believed to occur at the weld toe due at least in part to high stress concentrations at the weld toe. Such stress concentrations are believed to often be the byproduct of a cold lap. To reduce the stress concentrations and/or the effects of cold laps, it may be desirable to develop a weld-bead geometry that has a smooth transition between the surfaces of the members being welded and the base of the weld-bead. One welding method that may address this desire is a method sometimes referred to as “multi-pass welding,” which may suffer from a number of possible drawbacks, such as, for example, a welded joint having minimal weld penetration.

Other methods for forming welded joints include, for example, the method disclosed in U.S. Pat. No. 6,649,870 (“the '870 patent”) issued to Barton et al. on Nov. 18, 2003. The '870 patent discloses providing a welding system and method that includes an arc welding subsystem, which utilizes one or more controlled process variables to facilitate geometric control of a toe angle, a toe radius, a throat dimension, and a penetration depth associated with the joining of the fillet weld and the one or more members. Although the welding method disclosed in the '870 patent may provide improvements in a fillet weld, it may not be suitable for providing a fillet weld with, for example, a general concave shape.

The apparatuses and methods of the present disclosure may be directed toward mitigating or overcoming drawbacks associated with existing welding technology.

### SUMMARY

In one aspect, the present disclosure is directed to a method for welding an edge of a first member to a side surface of a second member. The first member and the second member may be joined to one another at a joint. The method may include beveling an edge of the first member. The method may also include positioning the edge of the first member proximate the side surface of the second member. The method may further include supplying welding material via a welding wire along the edge of the first member to create a joint between the first member and the second member. Supplying welding material may include controlling a feed rate of the welding wire, such that a weld bead formed at the joint may define a concave cross-section.

In another aspect, a method for improving fatigue life of a welded joint between a first member and a second member may include positioning an edge of the first member proximate a side surface of the second member. The method may also include supplying welding material via a welding wire along the edge of the first member to create a joint between the first and the second members. The method may further include controlling a feed rate of the welding wire according to a formula, V_{W}≦K·V_{T}·S_{weld}·(D_{W})⁻², where V_{W} is the feed rate of the welding wire, K is a coefficient, V_{T} is a travel speed of a welding assembly configured to supply welding material, S_{weld} is a cross-sectional area of the joint between the first and the second members, and D_{W} is related to a cross-sectional area of the welding wire.

In yet another aspect, an apparatus for welding an edge of a first member to a side surface of a second member may include a welding assembly operable to weld the edge of the first member to the side surface of the second member. The welding assembly may be configured to supply a welding wire to a joint between the first and second members at a feed rate. The apparatus may further include a processor operably coupled to the welding assembly. The processor may be configured to store one or more weld variable parameters, and to control the welding assembly based on at least one of the weld variable parameters and a formula, V_{W}≦K·V_{T}·S_{weld}·(D_{W})⁻², where V_{W} is the feed rate of the welding wire, K is a coefficient, V_{T} is a travel speed of the welding assembly, S_{weld} is a cross-sectional area of the joint between the first and second members, and D_{W} is related to a cross-sectional area of the welding wire.

### BRIEF DESCRIPTION OF THE DRAWINGS

FIG. 1 is a schematic representation of an exemplary embodiment of a welding assembly;

FIG. 2 is a schematic representation of an exemplary embodiment of two members welded to one another;

FIG. 3 is a flow diagram illustrating an exemplary method for welding an edge of a first member to a side surface of a second member; and

FIG. 4 is a flow diagram illustrating an exemplary method for improving fatigue life of a welded joint between a first member and a second member.

### DETAILED DESCRIPTION

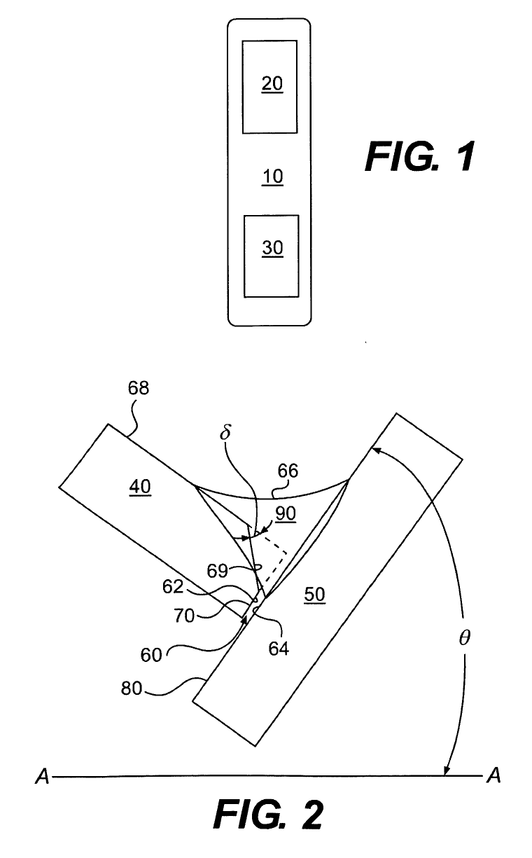

An exemplary embodiment of a welding assembly 10 is schematically illustrated in FIG. 1. Welding assembly 10 may be configured to perform a variety of welding processes, such as fillet welding, multi-pass welding, and Fabrication of Advanced Structures Using Intelligent and Synergic Materials Processing (FASIP) welding, as well as other welding methods known to those having ordinary skill in the art. Referring to FIG. 2, welding assembly 10 may be used, for example, to join a first member 40 and a second member 50. For example, first member 40 and second member 50 may be joined to one another at a joint 60. As used herein, “joint” may refer to an area associated with an interface, for example, where an edge 70 of first member 40 meets a side surface 80 of second member 50. It is contemplated that first member 40 may be made from metals and metal alloys, such as, for example, steel, steel alloys, aluminum, aluminum alloys, titanium, and titanium alloys. It is also contemplated that second member 50 may be made from materials similar to the materials of first member 40.

According to some embodiments, for example, as shown in FIG. 1, welding assembly 10 may be configured to be operated manually, for example, by an operator holding and guiding welding assembly 10 along a junction between two or more members being welded to one another. According to some embodiments, welding assembly 10 may include a memory 20 and/or a controller 30. In some embodiments, welding assembly 10 may include additional components (not shown), such as, for example, a wire holder for holding a welding wire, a device for providing a gas stream for use with shielded arc welding, and/or a member for directing a shielding gas, as well as other components known to those skilled in the art. Some embodiments of welding assembly 10 may be operated by an operator during welding and/or after being set-up to weld according to one or more settings made prior to welding. According to some embodiments, such settings may be made remotely, for example, via a communication system (e.g., a wired- and/or wireless-communication system).

According to some embodiments, welding robots may be employed to operate welding assembly 10. This includes, for example, welding robots from ABB Ltd., Motoman, Inc., FANUC Robotics, Inc., Panasonic Factory Solutions Company of America, and/or other welding devices known to those skilled in the art. In some embodiments, operation of welding assembly 10 may be controlled via the use of memory 20 and/or controller 30. For example, memory 20 may be configured to store a plurality of weld variable parameters associated with welding assembly 10. The plurality of parameters may include, for example, a travel speed of welding assembly 10, a feed rate of a welding wire, a cross-section and/or diameter of the welding wire, and/or a cross-sectional area of welded joint 60. Other weld variable parameters are contemplated. Controller 30 may be operably coupled to memory 20, and controller 30 may be configured to control welding assembly 10 based on one or more of the plurality of weld variable parameters, which may be stored in memory 20.

While memory 20 and controller 30 are shown in FIG. 1 as being included internally in (i.e., within) welding assembly 10, it is contemplated that memory 20 and/or controller 30 may be external to welding assembly 10. In some embodiments, memory 20 and controller 30 may be in the form of two separate components. In some embodiments, memory 20 and controller 30 may be in the form of a single component. For example, memory 20 and controller 30 may be combined and may be included in a processor (not shown), and the processor may be configured to store one or more weld variable parameters. According to some embodiments, the processor may be configured to control welding assembly 10 based on at least one of the weld variable parameters.

As illustrated in FIG. 2, second member 50 may be oriented at an angle θ with respect to a plane A (e.g., a generally horizontal plane). For example, angle θ may be about forty-five degrees. Alternatively, second member 50 may be oriented at an angle ranging from about forty degrees to about sixty degrees with respect to the plane A (i.e., angle θ may be about forty degrees to about sixty degrees). According to some embodiments, edge 70 of first member 40 may be oriented generally orthogonal to side surface 80 of second member 50. Edge 70 and side surface 80 may be joined together at joint 60, which may be generally defined by, for example, joint interfaces 62 and 64. Joint 60 may include a cross-sectional area that may be defined by an area where joint interface 62 overlaps joint interface 64.

According to some embodiments, edge 70 may be beveled. For example, a portion of edge 70 may be removed, such that an angle δ may be formed by a surface 68 of first member 40 and beveled surface 69. Angle δ may range from about forty-five degrees to about seventy-five degrees. For example, angle δ may be about sixty degrees.

According to some embodiments (not shown), a supply of welding material may be operably coupled to welding assembly 10. For example, the welding material supply may be located internal and/or external to welding assembly 10. For some embodiments, welding material may be supplied via one or more welding wires. The welding wires may be made from materials that are in the same class and/or category as first member 40 and second member 50. For example, the welding wires may be metals and metal alloys.

Welding assembly 10 may be configured to supply welding material to joint 60. For example, welding assembly 10 may be configured to feed welding material to joint 60 at a feed rate configured to result in a fatigue-resistant weld. The feed rate may be controlled manually, for example, via an operator holding and guiding welding assembly 10, and/or automatically via welding assembly 10 according to pre-adjusted settings. As welding material is fed to joint 60, welding material may collect and form a weld bead 90 at joint 60.

Weld bead 90 may generally define a cross-sectional area defining at least one concave side, for example, such that weld-bead surface 66 is concave with respect to surface 68 of first member 40 and/or side surface 80 of second member 50. Weld bead 90 may define cross-sectional areas having various shapes, depending on factors, such as, for example, the relative orientation of first member 40 and second member 50.

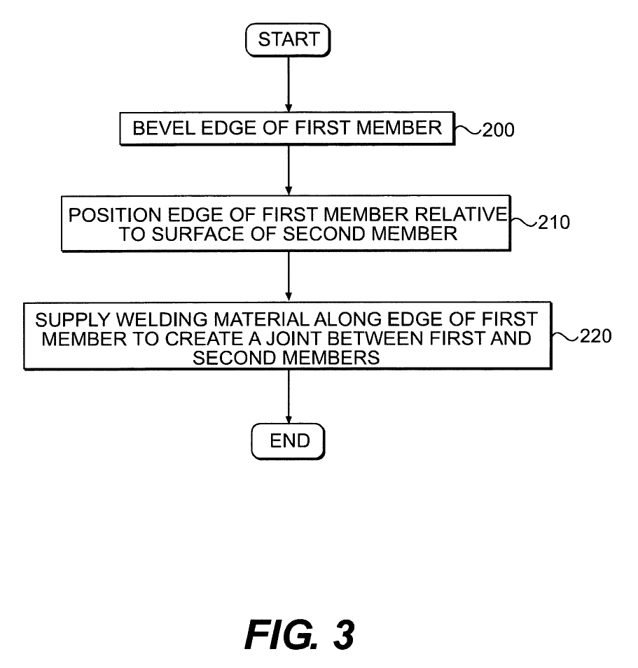

FIG. 3 schematically depicts an exemplary method for welding an edge of a first member 40 to a side surface 80 of a second member 50. The exemplary method may begin with Step 200, where edge 70 (see FIG. 1) of first member 40 may be beveled. For example, at Step 200, a portion of edge 70 may be removed, thereby forming beveled surface 69. In some embodiments, edge 70 may be positioned approximate side surface 80 (Step 210). For example, edge 70 may be positioned such that first member 40 extends in a direction generally orthogonal with respect to side surface 80. At Step 220, welding material may be supplied along edge 70. For example, the welding material may be supplied via feeding a welding wire at a feed rate (e.g., a predetermined feed rate chosen to improve fatigue-resistance of the welded joint). The welding material supplied may serve to join edge 70 and side surface 80 at joint 60. The welding material may be supplied by, for example, exemplary welding assembly 10.

It is contemplated that the supply of welding material to joint 60 may be controlled either manually or automatically. For example, an operator may manually hold and guide welding assembly 10 along edge 70 such that welding wire is fed at a feed rate to form weld bead 90. According to some embodiments, the supply of welding material may be controlled, for example, based on a plurality of weld variable parameters. According to some embodiments, the weld variable parameters may be similar to the plurality of weld variable parameters described previously herein. For example, the feed rate of the welding wire may be automatically controlled via welding assembly 10, thereby forming weld bead 90 at joint 60.

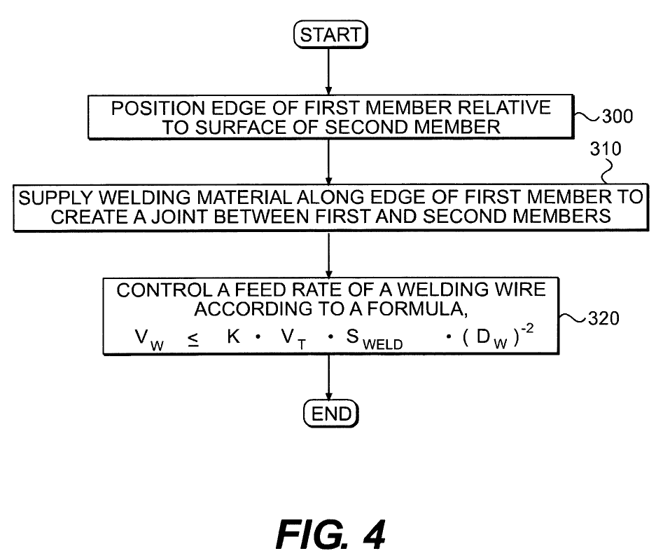

FIG. 4 schematically depicts an exemplary method for improving fatigue life of a welded joint between a first member 40 and a second member 50. The method may start with Step 300, where edge 70 (see FIG. 1) of first member 40 may be positioned approximate side surface 80 of second member 50. For example, edge 70 may be positioned generally orthogonal with respect to side surface 80. At Step 310, welding material may be supplied along edge 70. For example, the welding material may be supplied via a welding wire. The welding material supplied may serve to join edge 70 and side surface 80 at joint 60. The welding material may be supplied by, for example, exemplary welding assembly 10.

According to the exemplary embodiment shown in FIG. 4, the supply of the welding material may be controlled at Step 320. For example, a feed rate of a welding wire may be controlled according to a formula,

V_{W}≦K·V_{T}·S_{weld}·(D_{W})⁻²,

where V_{W} is the feed rate of the welding wire, K is a coefficient, V_{T} is a travel speed of the welding assembly, S_{weld} is a cross-sectional area of the joint between the first and second members, and D_{W} is related to the cross-sectional area of the welding wire (e.g., a diameter of the welding wire).

### INDUSTRIAL APPLICABILITY

Referring to FIG. 2, second member 50 may be positioned at an angle with respect to plane A, which may be, for example, generally horizontal. For example, second member 50 may be positioned at approximately forty-five degrees with respect to plane A. In some embodiments, first member 40 may be positioned generally orthogonal with respect to second member 50. For example, first member 40 and second member 50 may be positioned such that joint 60 may be formed. Positioning first member 40 and second member 50 in such a manner may facilitate a deeper penetration of welding material at joint 60 (i.e., relative to instances where first member 40 and second member 50 are not positioned as described), due to, for example, force of gravity.

In some embodiments, edge 70 may be beveled such that a portion of edge 70 may be removed. The beveling of edge 70 may help to define a space at joint 60. The space may serve to deepen the penetration of weld bead 90 at joint 60 (i.e., relative to weld bead 90 that may be formed at joint 60 in instances where edge 70 may not have been beveled). The penetration of weld bead 90 at joint 60 may, for example, range from about 7 millimeters to about 9 millimeters. The deeper penetration at joint 60 may serve to improve the strength of weld bead 90. The deeper penetration at joint 60 may also serve to improve the fatigue life of weld bead 90. Weld bead 90 may generally define a cross-sectional area defining at least one concave surface (e.g., weld-bead surface 66). The concave surface may serve to improve the fatigue life of weld bead 90, which may also strengthen the connection between first member 40 and second member 50 at joint 60.

In embodiments where the supply of the welding material may be controlled according to the formula,

V_{W}≦K·V_{T}·S_{weld}·(D_{W})⁻²,

where V_{W} is the feed rate of the welding wire, K is a coefficient, V_{T} is the travel speed of the welding assembly, S_{weld} is the cross-sectional area of the joint between first member 40 and second member 50, and D_{W} is the diameter the welding wire, the following exemplary values may be used for each of the parameters listed in the formula. For example, K may range from about 0.382 to about 0.573, V_{T} may range from about 4 inches per minute to about 12 inches per minute, S_{weld} may range from about 20 square millimeters to about 35 square millimeters, and D_{W} may range from about 0.035 inches to about 0.064 inches (e.g., 0.035 inches, 0.052 inches, or 0.064 inches). In embodiments where shielding gas may used, the shielding gas may be a mixture of Argon and Carbon Dioxide. Further, in embodiments where a multi-pass welding technique is employed, it is contemplated that during different passes, the welding wire may be oriented differently with respect to plane A. For example, during an initial pass, the welding wire may be fed in an orientation that may be at about 20 degrees with respect to plane A. During subsequent passes, the welding wire may be fed in an orientation that may be generally orthogonal to plane A. Alternatively, the welding wire may be fed at the same orientation with respect to plane A during all passes, or the welding wire may be fed in different orientations with respect to plane A during the passes.

It will be apparent to those skilled in the art that various modifications and variations can be made in the disclosed apparatuses and methods for welding and improving fatigue life of a welded joint of two members. Other embodiments will be apparent to those skilled in the art from consideration of the specification and practice of the disclosed embodiments herein. It is intended that the specification and examples be considered as exemplary only, with a true scope of the disclosure being indicated by the following claims.

What is claimed is:

1. A method for welding an edge of a first member to a side surface of a second member, such that the first member and the second member are joined to one another at a joint, the method comprising:
beveling an edge of the first member;
positioning the edge of the first member proximate the side surface of the second member; and
supplying welding material via a welding wire along the edge of the first member to create a joint between the first member and the second member,
wherein supplying welding material comprises controlling a feed rate of the welding wire, such that a weld bead formed at the joint defines a concave cross-section.

2. The method of claim 1, further including positioning the side surface of the second member at an angle with respect to a generally horizontal plane, and positioning the edge of the first member generally orthogonal to the side surface of the second member.

3. The method of claim 2, wherein positioning the side surface of the second member includes positioning the side surface of the second member at an angle of about forty-five degrees with respect to the generally horizontal plane.

4. The method of claim 1, wherein supplying welding material includes controlling a plurality of weld variable parameters associated with a welding assembly configured to supply welding material.

5. The method of claim 4, wherein the plurality of weld variable parameters includes at least one of the feed rate of the welding wire, a coefficient, a travel speed of the welding assembly, a cross-sectional area of the joint between the first and second members, and a diameter of the welding wire.

6. The method of claim 1, wherein supplying welding material via a welding wire includes:
positioning the welding wire at an angle with respect to a generally horizontal plane; and
positioning the welding wire generally orthogonal to the generally horizontal plane.

7. The method of claim 6, wherein positioning the welding wire at an angle includes positioning the welding wire at an angle of about twenty degrees with respect to the generally horizontal plane.

8. A method for improving fatigue life of a welded joint between a first member and a second member, the method comprising:
positioning an edge of the first member proximate a side surface of the second member;
supplying welding material via a welding wire along the edge of the first member to create a joint between the first and second members; and
controlling a feed rate of the welding wire according to a formula,
V_{W}≦K·V_{T}·S_{weld}·(D_{W})⁻²,
where V_{W} is the feed rate of the welding wire, K is a coefficient, V_{T} is a travel speed of a welding assembly being configured to supply welding material, S_{weld} is a cross-sectional area of the joint between the first and second members, and D_{W} is related to a cross-sectional area of the welding wire.

9. The method of claim 8, wherein supplying welding material includes forming a weld bead at the joint between the first and second members, wherein the weld bead defines a concave cross-section.

10. The method of claim 8, wherein controlling a feed rate includes controlling the feed rate according to the formula, where K ranges from about 0.4 to about 0.6.

11. The method of claim 8, further including positioning the side surface of the second member at an angle with respect to a generally horizontal plane, and positioning the edge of the first member generally orthogonal to the side surface of the second member.

12. The method of claim 11, wherein positioning the side surface of the second member includes positioning the side surface of the second member at an angle of about forty-five degrees with respect to the generally horizontal plane.

13. The method of claim 8, wherein supplying welding material via a welding wire includes:
positioning the welding wire at an angle with respect to a generally horizontal plane; and
positioning the welding wire generally orthogonal to the generally horizontal plane.

14. The method of claim 13, wherein positioning the welding wire at an angle includes positioning the welding wire at an angle of about twenty degrees with respect to the generally horizontal plane.

15. An apparatus for welding an edge of a first member to a side surface of a second member, comprising:
a welding assembly operable to weld the edge of the first member to the side surface of the second member, the welding assembly being configured to supply a welding wire to a joint between the first and second members at a feed rate; and
a processor operably connected to the welding assembly, the processor being configured to store one or more weld variable parameters and control the welding assembly based on at least one of the one or more weld variable parameters and a formula,
V_{W}≦K·V_{T}·S_{weld}·(D_{W})⁻²,
where V_{W} is the feed rate of the welding wire, K is a coefficient, V_{T} is a travel speed of the welding assembly, S_{weld} is a cross-sectional area of the joint between the first and second members, and D_{W} is related to a cross-sectional area of the welding wire.

16. The apparatus of claim 15, wherein the processor includes a memory for storing the one or more weld variable parameters, and a controller operably coupled to the memory and the welding assembly, the controller being configured to control the welding assembly based on at least one of the one or more weld variable parameters.

17. The apparatus of claim 15, wherein the welding assembly is configured to form a weld bead at the joint, wherein the weld bead defines a concave cross-section.

18. The apparatus of claim 15, wherein K ranges from about 0.4 to about 0.6.
